(19) United States
(12) Patent Application Publication
(10) Pub. No.: US 2023/0232815 A1
(43) Pub. Date: Jul. 27, 2023

(54) A RECHARGEABLE TRAP WITH PISTONS OR SPEARS OF VARYING WEIGHTS

(71) Applicant: CAMRO A/S, Norager (DK)

(72) Inventor: Kurt Sorensen, Norager (DK)

(21) Appl. No.: 18/009,797

(22) PCT Filed: Jun. 10, 2021
(86) PCT No.: PCT/EP2021/065617

§ 371 Date: Dec. 12, 2022

(30) Foreign Application Priority Data
Jun. 15, 2020 (DK) PA 2020 00696

(51) Int. Cl. A01M 23/36

(52) U.S. Cl. CPC A01M 23/36

(57) ABSTRACT

The present invention relates to the use of a kit of pistons or spears of varying weights for preparing a rechargeable trap for a specific target species, and to a rechargeable trap with pistons or spears of varying weights.

### TECHNICAL FIELD OF THE INVENTION

The present invention relates to the field of traps, especially for rodents.

### BACKGROUND OF THE INVENTION

Inherent flaws in the basic design of traps to date create problems with non-target bycatch issues, when birds, lizards, snakes, kittens, etc. are caught in traps set for pests, inciting negative public reaction. Other types of traps, such as live capture cage traps and leg-hold traps, have the disadvantage of being much bulkier and/or of heavy construction. They merely restrain rather than kill the animals, and unless checked regularly at short time intervals will cause captured animals unnecessary stress and suffering.

As concern for animal rights grows worldwide, and international animal welfare regulations become more stringent, particularly in relation to perceived indiscriminate use of toxins and inefficient traps, the number and type of traps available is diminishing.

### OBJECT OF THE INVENTION

The objective of the present invention is to provide a rechargeable trap adapted for reducing non-target bycatches.

### DESCRIPTION OF THE INVENTION

Mechanical traps are characterised by killing means that strikes the rodent and almost instantly kills the rodent. The killing means in mechanical traps are normally spring driven or gas pressure driven and may be recharged by electrical means or gas pressure driven means. The present invention relates to mechanical traps with a killing means in the form of a piston or spear.

A first aspect of the present invention relates to a rechargeable trap comprising:
a spring driven and/or gas pressure driven killing means; said killing means comprising:
i) a piston or spear with a replaceable core, said core being selected from a kit of cores of varying weights; and/or
ii) a replaceable piston or spear, said piston or spear being selected from a kit of pistons or spears of varying weights.

A second aspect relates to a rechargeable trap comprising:
a spring driven and/or gas pressure driven killing means; said killing means comprising:
i) a piston or spear with a cavity adapted for receiving a core part, and a kit of cores parts of varying weights; and/or
ii) a base unit adapted for receiving a piston or spear, and kit of pistons or spears of varying weights.

A third aspect relates to the use of a kit of pistons or spears of varying weights for preparing a rechargeable trap for a specific target species.

In one or more embodiments, the use comprises providing a piston or spear with a replaceable core, and selecting a core to insert into said piston or spear from a kit of cores of varying weights, said selected core being suitable for killing a specific target species.

The advantage of using a trap that can regulate the weight of the piston or spear is that the trap can be prepared for different types of target species. A relatively lightweight piston or spear may be suitable for killing e.g. mice, whereas a relatively heavier piston or spear is suitable for killing e.g. rats or even larger animals.

In one or more embodiments, the killing means comprises:
a piston or spear with a replaceable core, and
a kit of cores of varying weights adapted for replacing said replaceable core.

In one or more embodiments, the piston or spear comprises a cavity adapted for receiving the core.

In one or more embodiments, the piston or spear comprises a cavity adapted for receiving a threaded core. The cavity is not necessarily threaded and is preferably smooth. This configuration secures that the core is properly fastened within the piston or spear's cavity without the use of glue. Furthermore, it allows for an easy exchange of cores. Preferably, the core is shaped as a set screw, thereby allowing for complete insertion into the piston or spear's cavity.

In one or more embodiments, the rechargeable trap further comprises:
a housing with an entrance; and
an insert adapted for releasably fastening in said entrance and adapted for restricting the width and/or height of said entrance. Preferably, the insert is adapted for restricting the width and/or height of a part of said entrance holding a trigger mechanism adapted for releasing the piston or spear.

In one or more embodiments, the rechargeable trap further comprises:
a housing with an entrance; and
a kit of inserts, each adapted for releasably fastening in said entrance and adapted for restricting the width and/or height of said entrance;
   wherein each insert is configured for the size of a specific target species. Preferably, the insert is adapted for restricting the width and/or height of a part of said entrance holding a trigger mechanism adapted for releasing the piston or spear.

The advantage of such an insert as mentioned above is that the user can choose to restrict certain non-target species from entering the trap compartment (or at least preventing non-target species from triggering a trigger mechanism adapted for releasing the piston or spear) and at the same time allowing a target species to enter. This is important if the user has installed e.g. a piston or spear for killing a mouse. If a rat enters, there is a substantial risk that the piston or spear will only invalidate the rat rather than killing it. In this way, the housing may be used for different targets. The insert may be made from any suitable material that a rodent is not prone to gnaw in, such as metal, preferably steel, plastic, or composite materials.

The housing may be made from any suitable material, such as metal, plastic, composites, concrete, or the like.

One type of insert may e.g. comprise an opening sized and shaped to prevent a rat from passing therethrough, and at the same time allowing a mouse to pass. Such an opening may have a diameter of 5-18 mm, and preferably a diameter of 10-17 mm, and even more preferably a diameter of 15-17 mm. Another type of insert may e.g. comprise an opening sized and shaped to prevent a bird and/or a squirrel from passing therethrough, and at the same time allowing a rat to pass. Such an opening may have a diameter of 19-30 mm, and preferably a diameter of 20-28 mm, and even more preferably a diameter of 22-24 mm.

In one or more embodiments, the kit of inserts comprises:
a first insert with an opening having a diameter of 5-18 mm, and preferably a diameter of 10-17 mm, and even more preferably a diameter of 15-17 mm; and
a second insert with an opening having a diameter of 19-30 mm, and preferably a diameter of 20-28 mm, and even more preferably a diameter of 22-24 mm.

Often, a scent attractant is positioned within the feeding and/or trap compartment to lure the target species therein. In such a situation, it may be an advantage to allow as much as possible of the scent to escape through the insert. In one or more embodiments, the insert is perforated with holes and/or slots. Preferably, the holes have a diameter of 3-8 mm, preferably about 5 mm, such as within the range of 4-7 mm, e.g. 5-6 mm. Preferably, the slots have a width of 3-8 mm, preferably about 5 mm, such as within the range of 4-7 mm, e.g. 5-6 mm.

It may be an advantage if the target species can enter the housing through a channel or via a hallway within which it may hide. The channel or hallway may be without a floor in order to make the target species feel safe by being able to move around, hide, and rest on a familiar surface. In one or more embodiments, the housing further comprises a channel or hallway leading to said entrance. Preferably, the channel or hallway is without a floor. In some embodiments, the hallway may comprise one or more entry openings, preferably multiple entry openings. Such an opening may be an opening similar in size as the above-mentioned insert. The opening may be restricted in size by inserts, and hence, the trap may comprise a kit of inserts, each insert suitable for being inserted into an opening in a hallway. The openings in the hallway may be provided with one or more rows of serrated protrusions. When a larger animal, a child, or even a curious adult tries to force the paw/hand through the opening, the response of withdrawal is immediate due to the unpleasant sensation of the serrated protrusions.

The use of the term “serrated” or “serrations” in this disclosure will generally be used to refer to an object having teeth, ridges, peaks, points, projections and/or protrusions extending from the surface thereof. These serrations can be of any shape, preferably having points or sharp edges. Further, although a serration is generally referred to as extending from a surface, one of skill in the art would recognize that a serration may be formed by removing portions of a surface to form valleys, troughs or the like resulting in the creation of corresponding serrations extending from a new surface.

In one or more embodiments, the entrance and/or opening in the channel or hallway has a width of at least 40 mm, such as within the range of 40-100 mm, e.g. at least 45 mm, such as within the range of 45-95 mm, e.g. at least 50 mm, such as within the range of 50-90 mm, e.g. at least 55 mm, such as within the range of 55-85 mm, e.g. at least 60 mm, such as within the range of 60-80 mm, e.g. at least 65 mm, such as within the range of 70-75 mm, e.g. at least 70 mm.

In order to further reduce the non-target poisonings and bycatches, it may be an advantage to equip the entrance with a gnaw through plate blocking the passage. Thereby, only rodents are prone to enter the entrance. A gnaw through plate suitable for a rat and/or mouse to gnaw through may be of many types, such as a material comprising or consisting of a polymer material, a starch material, a lignin material, such as cardboard, a protein material, or the like. Preferably, the material is un-dissolvable by snails or slugs.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE FIGURES

FIG. 1 is a partly exploded and perspective view of a trap in accordance with various embodiments of the invention;

FIG. 2 is a cross-sectional view of a trap in accordance with various embodiments of the invention;

FIG. 3 shows a piston or spear in accordance with various embodiments of the invention;

FIG. 4 is a cross-sectional view of a piston or spear in accordance with various embodiments of the invention; and

FIG. 5 shows an insert in accordance with various embodiments of the invention.

### REFERENCES

100 Trap

110 Killing means

120 Trigger rod

130 Gas tank

150 Lure/bait housing

160 Spring

200 Piston or spear

210 Core

220 Cavity

300 Housing

310 Entrance

400 Insert

500 hallway

510 Entry opening

520 Serrated protrusions

### DETAILED DESCRIPTION OF THE INVENTION

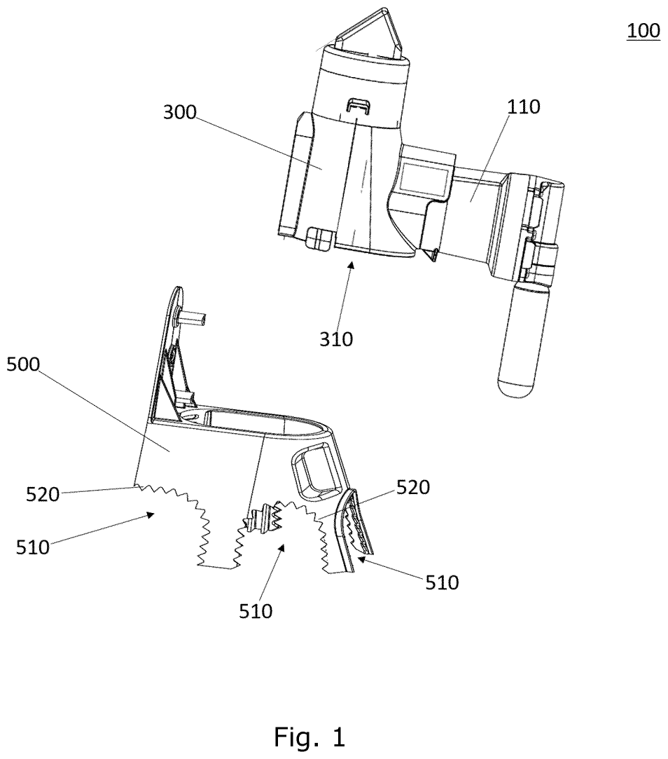

FIG. 1 is a partly exploded and perspective view of a trap 100 in accordance with various embodiments of the invention and is not meant to be limiting for the scope of the invention. The trap 100 comprises a spring driven, and gas pressure driven killing means 110, a housing 300 with an entrance 310, and a hallway 500 leading to said entrance 310. Here, the spring 160 secures that the piston or spear is retracted after being released/fired by gas propulsion.

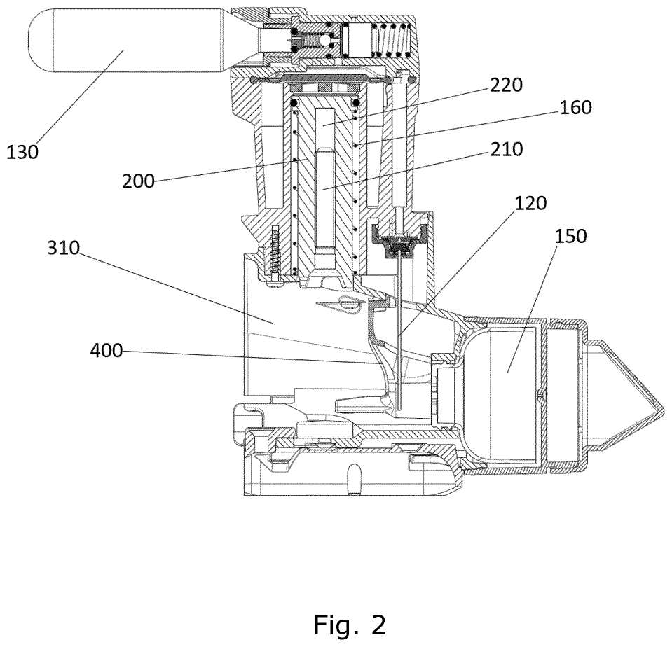

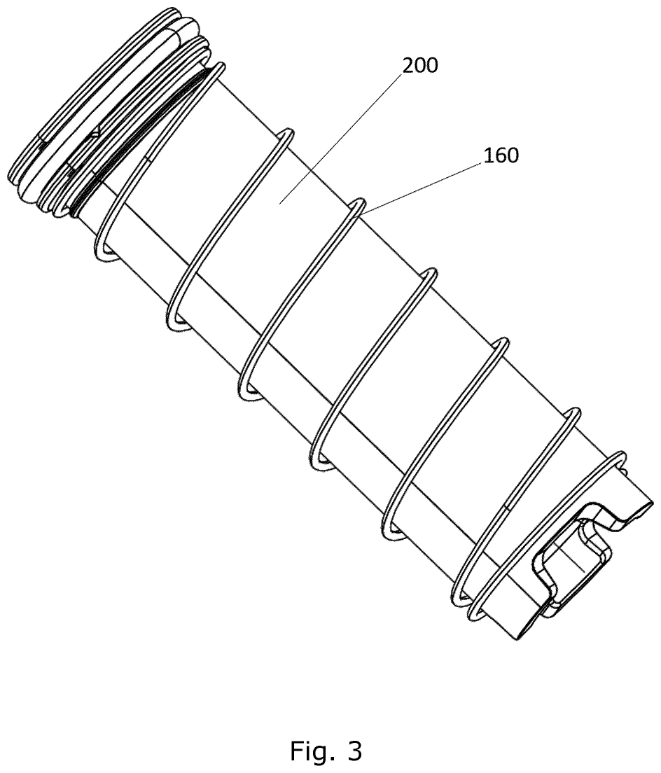

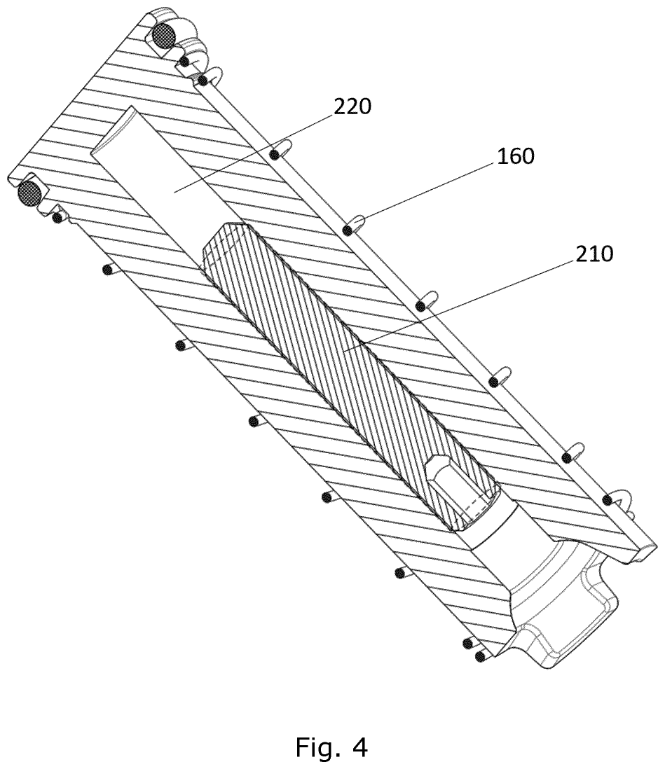

FIG. 2 is a cross-sectional view of a trap 100 in accordance with various embodiments of the invention. The trap 100 is here shown with a piston or spear 200 comprising a smooth cavity 220 with a replaceable core 210 positioned therein. The core 210 may be selected from a kit of cores of varying weights. The weight of the core 210 can be varied by keeping the volume fixed and changing its density, e.g. by providing cores of different material. Alternatively, or in combination, the length or width of the core 210 may be varied. In the shown embodiment, only the length and the density may be varied due to the limitation of the cavity width. It is important that the core 210 is fixed within the cavity 220 since it would otherwise not provide the same impact on a target species when the piston or spear strikes. Furthermore, it may otherwise damage the other components of the piston or spear. Hence, it is advantageous that the piston or spear 200 comprises a cavity 220 adapted for receiving a threaded core 210. The piston or spear 200 is both gas driven, and spring driven. The gas tank 130 (FIGS. 1 and 2) and the spring 160 (FIGS. 2-4) are shown in some of the figures. The piston or spear 200 is activated by the trigger rod 120 and is shown in a retracted position. Apart from the cavity, the piston or spear 200 is preferably made from a polymeric material that is preferably injection mouldable, such as plastic, e.g. polyethylene, polyoxymethylene, or polyethylene. The piston or spear 200 could though be made of metal, such as steel or the like.

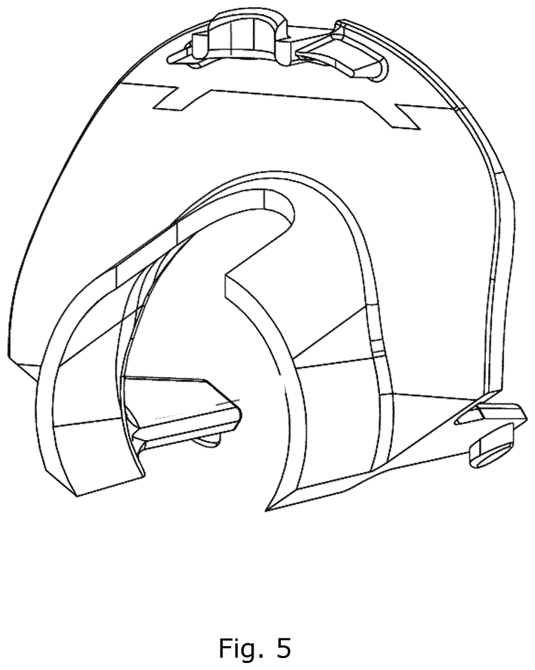

The trap housing 300 (FIGS. 1 and 2) with an entrance 310. An insert 400 is positioned (releasably fastened) within the entrance 310 and in front of the trigger rod 120 and lure/bait housing 150. The intention is that only targeted animals can reach the trigger rod 120. Hence, the insert 400 is adapted for restricting the height and width of the entrance 310, and may be selected from a kit of inserts, each adapted for targeting a specific animal/specie. An example of an insert 400 may be seen in FIG. 5, and may have many different shapes, depending on the shape of the entrance into which it is inserted.

A further means to reduce non-targeted species is to mount a hallway 500 (FIG. 1) in front of the entrance 310. The hallway 500 is here exemplified with five entry openings 510 (only four may be seen). The entry openings 510 each have a size restricting non-target species from entering the hallway 500, such as larger non-target species, e.g. cats. The entry openings 510 are provided with serrated protrusions 520 to further discourage non-target species form e.g. trying to insert their paws or hands into the entrance 310 via the hallway 500.

1. A fit, comprising pistons or spears of varying weights for preparing a rechargeable trap for a specific target species.

2. The kit of claim 1, comprising providing a piston or spear with a replaceable core, and selecting a core to insert into said piston or spear from a kit of cores of varying weights, said selected core being suitable for killing a specific target species.

3. A rechargeable trap (100) comprising:
a spring driven and/or gas pressure driven killing means (110); said killing means comprising:
i) a piston or spear (200) with a replaceable core (210), said core (210) being selected from a kit of cores of varying weights; and/or
ii) a replaceable piston or spear, said piston or spear being selected from a kit of pistons or spears of varying weights.

4. The rechargeable trap (100) according to claim 3, wherein said killing means comprises:
a piston or spear (200) with a replaceable core (210), and
a kit of cores of varying weights adapted for replacing said replaceable core (210).

5. The rechargeable trap (100) according to claim 3, wherein said piston or spear (200) comprises a cavity (220) adapted for receiving a threaded core (210).

6. The rechargeable trap (100) according to claim 3, wherein said piston or spear comprises a cavity adapted for receiving said core.

7. The rechargeable trap (100) according to claim 3, further comprising:
a housing (300) with an entrance (310); and
an insert (400) adapted for releasably fastening in said entrance (310) and adapted for restricting the width and/or height of said entrance (310).

8. The rechargeable trap (100) according to claim 7, further comprising:
a channel or via a hallway (500) leading to said entrance (310); said channel or hallway (500) comprising one or more entry openings (510); said entry openings (510) optionally being a) of similar in size as said insert (400) and/or b) adapted for receiving an insert adapted for restricting the size of said entry opening (510).

9. The rechargeable trap (100) according to claim 8, wherein said entry openings (510) in said channel or hallway (500) are provided with one or more rows of serrated protrusions (520).

10. A method of preparing a rechargeable trap (100) for a specific target species comprising the steps of:
a) determining which species to target;
a) providing a trap (100) according to claim 3;
b1) selecting a piston or spear from a kit of pistons or spears of varying weights, said piston or spear suitable for killing said specific target species;
and/or
b2) selecting a core (210) from a kit of cores of varying weights and suitable for being load into a piston or spear (200) of said trap (100) to provide a piston or spear with a suitable weight for killing said specific target species; and
c) installing said piston or spear (200) into said trap (100).
